(19) United States
(12) Patent Application Publication
(10) Pub. No.: US 2007/0207806 A1
(43) Pub. Date: Sep. 6, 2007

(54) WIRELESS COMMUNICATION METHOD AND SYSTEM FOR PERFORMING DUAL MODE PAGING

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/627,007

(22) Filed: Jan. 25, 2007

Related U.S. Application Data
(60) Provisional application No. 60/763,496, filed on Jan. 30, 2006.

(51) Int. Cl. H04Q 7/20

(52) U.S. Cl. 455/436

(57) ABSTRACT

A wireless communication method and system for performing dual mode paging over a wireless communication network having both a second-generation/third-generation (2G/3G) radio access network (RAN) and an evolved-universal mobile telecommunication system (UMTS) terrestrial radio access network (E-UTRAN). When a wireless transmit/receive unit (WTRU) registers or originates traffic with an evolved network, no additional signaling is required Otherwise, the WTRU is paged via both of the 2G/3G RAN and the E-UTRAN, depending on the response from the WTRU, data is forwarded to the WTRU via the 2G/3G RAN or the E-UTRAN.

### CROSS REFERENCE TO RELATED APPLICATION

This application claims the benefit of U.S. provisional application No. 60/763,496 filed on Jan. 30, 2006 which is incorporated by reference as if fully set forth.

### FIELD OF INVENTION

The present invention is related to wireless communication systems. More particularly, the present invention is related to dual mode paging in a wireless communication system including a second-generation (2G)/third-generation (3G) radio access network (RAN) and an evolved-universal mobile telecommunication system (UMTS) terrestrial radio access network (E-UTRAN).

### BACKGROUND

As 3G and Long Term Evolution (LTE) technology is widely introduced, one key consideration is the need for continuing to provide service using older 2/2.5G technologies as well as 3G and LTE technologies in a seamless fashion. However, it will take some time before the geographical coverage and network capacity of 3G and LTE based networks will match that achieved by older 2/2.5G networks. Also the nature of 3G and LTE systems may mandate different footprints within the same coverage area, for example, LTE cells may be smaller than that of 3G and 2/2.5G technologies.

Where 3G or LTE coverage is absent, the user will need to utilize the older 2/2.5G networks, and wireless transmit/receive units (WTRUs) operating in the networks will require the support of multiple radio access technologies (RATs), thus requiring a multi-RAT WTRU capability. Not only must the multi-RAT WTRUs be capable of searching for other types of RAT networks at power-up, but the multi-RAT WTRUs must also be capable of re-selecting the network type when moving out of the LTE coverage area.

During an inter-RAT handover, the call/session must be handed over from one RAT network to another without any significant degradation of performance noticeable to the user of a dual-RAT WTRU. For general packet radio service (GPRS) capable multi-RAT WTRUs, the packet service connection must also be transferred to another network.

Intersystem handover is a process of maintaining a communication connection while moving from one cell of a first RAT network to another cell of a second RAT network. As LTE networks are deployed in geographical areas overlapping older 2G/2.5G networks, seamless inter-RAT handover will become critical to providing users with uninterrupted service and reachablility. Therefore, inter-RAT handover techniques that do not affect a WTRU's performance are desired.

### SUMMARY

The present invention is related to a wireless communication method and system for performing dual mode paging for multi-mode terminal operation in that system. The wireless communication system includes an E-UTRAN, a 2G/3G RAN and at least one WTRU including an evolved element (EE) in communication with the E-UTRAN and a 2G/3G element in communication with the 2G/3G RAN. According the present invention, the WTRU shall be reachable in the LTE system while registered in 2G/3G system, and visa versa. The system may first attempt paging the WTRU over a 2G/3G RAN, and then attempt a second page on an LTE RAN. If the WTRU receives a first page message via the 2G/3G RAN, then it may respond on the 2G/3G RAN. If the WTRU did not receive the first page because it is camped on the LTE side, then it receives the second page message via the E-UTRAN. The WTRU responds to the second page message via the EE.

In an alternative embodiment, it is also possible that if the WTRU camped on the 2G/3G system receives the first page, then the WTRU may access the system in page response over the EUTRAN side. The network side supporting the EUTRAN is capable of connecting to the 2G/3G network side to ensure seamless operation. Paging via the 2G/3G network side may be more robust since the 2G/3G system footprint may be more reliable than those of an LTE network. Alternatively, a global system for mobile communication (GSM) enhanced data rate for global evolution (EDGE) radio access network (GERAN) may be used instead of the 2G/3G RAN.

The wireless communication system supporting EUTRAN further includes a mobility management entity (MME) and user plane entity (UPE) along with a serving general packet radio service (GPRS) support node (SGSN) that supports 2G/3G RANs. The SGSN is in communication with the MME/UPE and the 2G/3G RAN. By sending a notification via the SGSN to the WTRU, the MME/UPE is capable of supporting both first and a second page messages. In an alternative embodiment, the first page message may be generated by the SGSN while the second page message is generated by the MME/UPE based on notification received from the SGSN.

The WTRU may send a response to the first page message to the MME/UPE via the 2G/3G RAN and the SGSN. The WTRU may send a response to the second page message to the MME/UPE via the E-UTRAN. In order to ensure that the WTRU is reachable via different directions, it is also possible to have other permutations of the paging procedure, (e.g., page on 2G/3G RAN response on the LTE RAN; page on the LTE RAN and response on the 2G/3G RAN).

Upon changing the mode of transmission from LTE to 2G/3G radio, the WTRU may send a 2G/3G routing area (RA) update message to the 2G/3G RAN via the 2G/3G element to inform the system that it is operating in the 2G/3G mode. The 2G/3G RAN forwards the 2G/3G RA update message to the SGSN. The SGSN may update the MME/UPE by sending a 2G/3G RA update notification to MME/UPE. The SGSN update to the MME/UPE ensures that any traffic for this particular WTRU arriving at the MME/UPE shall be forwarded to the SGSN for delivery. The 2G/3G RAU is completed by updating the HSS/HLR about the current location/reachability of the WTRU. Upon successful completion, the RAU response message is sent from the SGSN to the 2G/3G RAN. The 2G/3G RAN forwards the 2G/3G RA update response message to the 2G/3G element of the WTRU.

In typical operations, the WTRU may receive messages from the MME/UPE via the E-UTRAN. The WTRU may also send messages to the MME/UPE via the E-UTRAN. The WTRU may also receive messages from the MME/UPE via the SGSN and the 2G/3G RAN. The WTRU may send user data to the MME/UPE via the 2G/3G RAN and the SGSN.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is an exemplary block diagram of an evolved dual mode paging communication system that is configured in accordance with the present invention; and

FIGS. 2A, 2B and 2C show signaling between the components of the system of FIG. 1 in accordance with various embodiments of the present invention.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The present invention is related to a method and system for an evolution or migration of the 3GPP wireless communication system to a higher data rate, lower latency, packet-optimized communication system that supports multiple RATs.

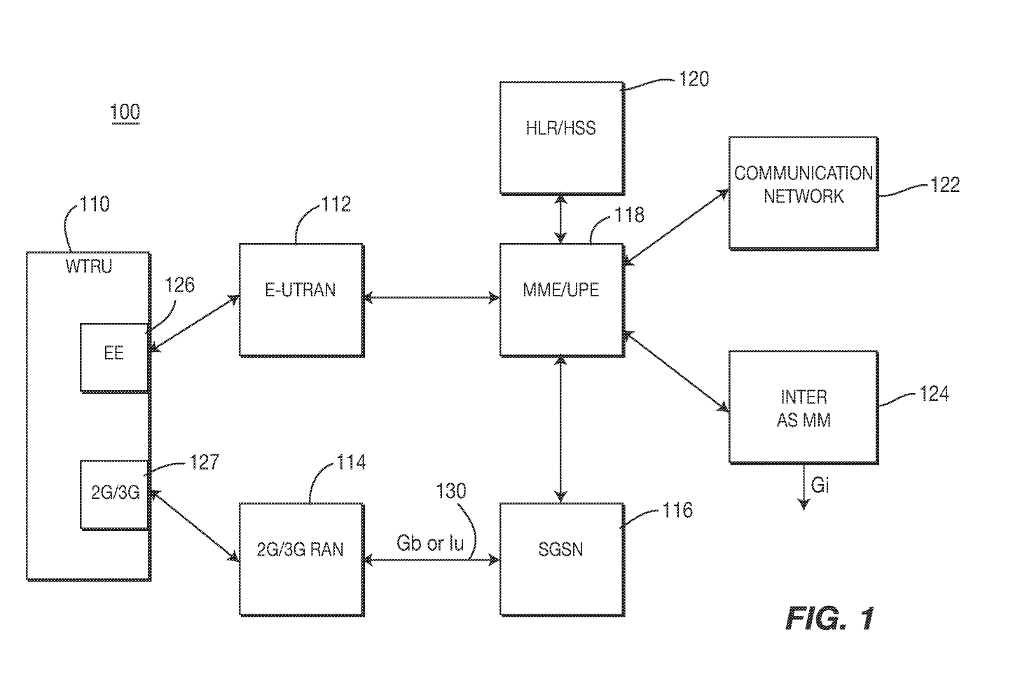

FIG. 1 is an exemplary block diagram of an evolved dual mode paging communication system 100 that is configured in accordance with the present invention. The system 100 includes at least one multi-RAT WTRU 110, an E-UTRAN 112, a 2G/3G RAN 114, an SGSN 116, am MME/UPE 118, a home location register (HLR)/home subscriber server (HSS) 120, a communication network 122 and an Inter access system (AS) mobility management (MM) unit 124. The Inter AS MM 124 is a gateway function that controls the handoff between 3GPP system, (e.g. 2G/3G and LTE systems), and non-3GPP systems, (e.g. WLAN, WiMAX, 3GPP2, CDMA2000 systems)

The WTRU 110 is configured for multi-mode paging according to the present invention and includes an evolved element (EE) 126 and a 2G/3G element 127. The WTRU 110 operates in either an evolved mode or a 2G/3G mode. Typically, when the WTRU 110 operates in the evolved mode, the WTRU 110 exchanges messages with the E-UTRAN 112 via the EE 126, and the E-UTRAN 112 exchanges messages with the MME/UPE 118. When the WTRU 110 operates in the 2G/3G mode, the WTRU 110 exchanges messages with the 2G/3G RAN 114 via the 2G/3G element 127, and the 2G/3G RAN 114 exchanges messages with the SGSN 116 via a Gb or Iu interface 130. The SGSN 116 keeps track of the location of the WTRU 110 and performs security and access control functions. The SGSN 116 exchanges messages with the MME/UPE 118 regarding the location of the WTRU 110, and its context information (e.g. security attributes, QoS profile, service profile). The connection between the SGSN 116 and MME/UPE 118 may also be used for forwarding paging messages for paging the WTRU 110 in either system; (SGSN 116 can forward paging to MME/UPE 118 to page the WTRU 110 on E-UTRAN 112, and the MME/UPE 118 may forward a page message to SGSN 116 to page the WTRU 110 on 2G/3G RAN 114).

Although FIG. 1 shows the SGSN 116 serving a generic 2G/3G RAN 114, in other embodiments the SGSN 116 may also be configured to serve a global system for mobile communication (GPRS) enhanced data rate for global evolution (EDGE) radio access network (GERAN).

The MME/UPE 118 is configured to send messages, and if necessary user data, to the communication network 122 and receive messages and user data from the communication network 122.

The MME function of the MME/UPE 118 manages and stores WTRU information, such as current state, identity and user security parameters. With this WTRU information, the MME of the MME/UPE 118 also generates temporary identifiers and allocates them to WTRUs, checks for authorization of the WTRUs that may camp on particular networks, and authenticates the WTRUs.

The UPE function of the MME/UPE 118 terminates, for idle state WTRUs, the downlink data path and triggers/initiates paging when downlink data arrives for the WTRU, and performs replication of the user traffic in the case of interception.

The HLR/HSS 120 performs many database functions that are required in next generation mobile networks. These functions, which are well known to those of skill in the art, include the HLR, domain name servers (DNS) and the security and network access database.

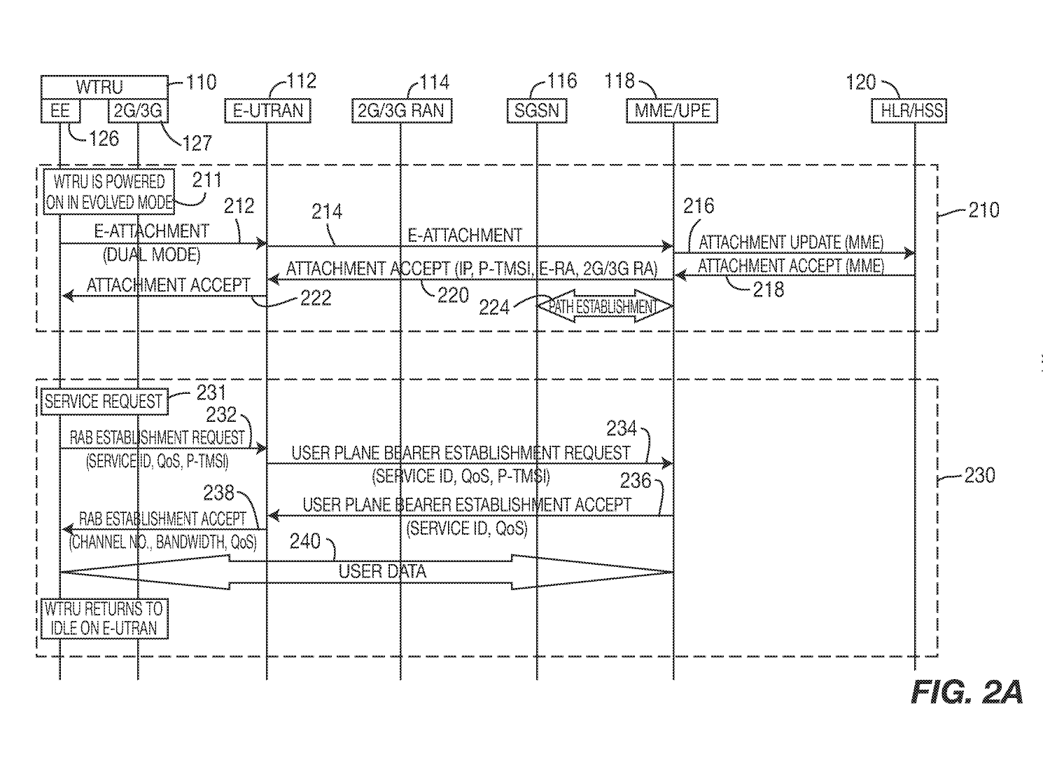

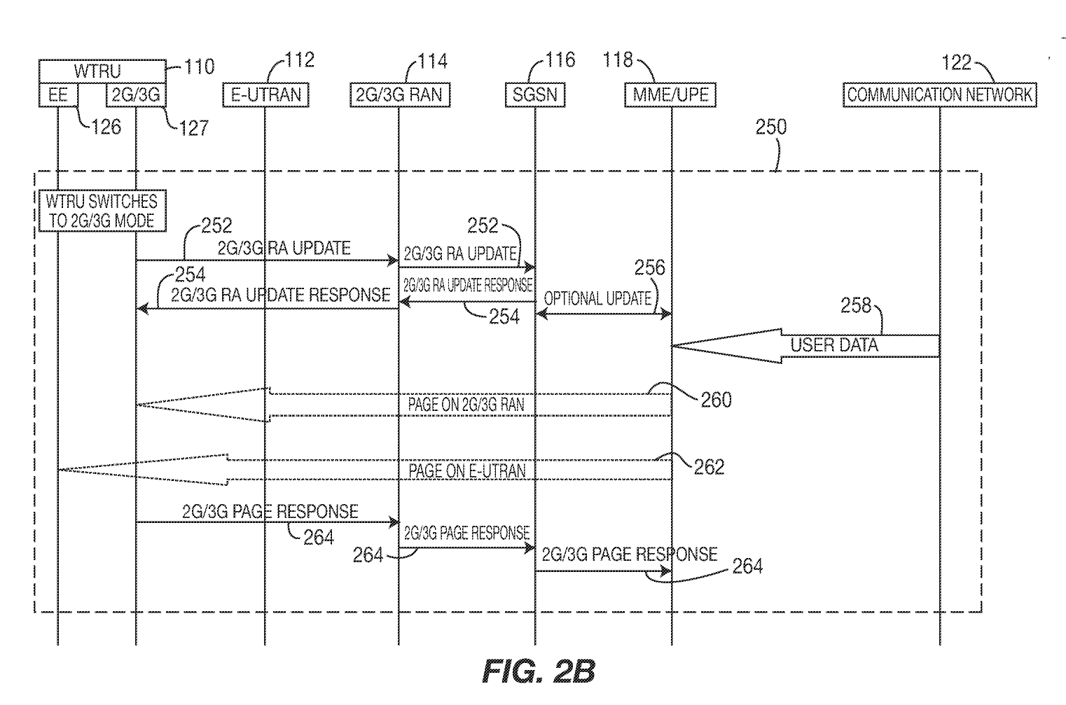

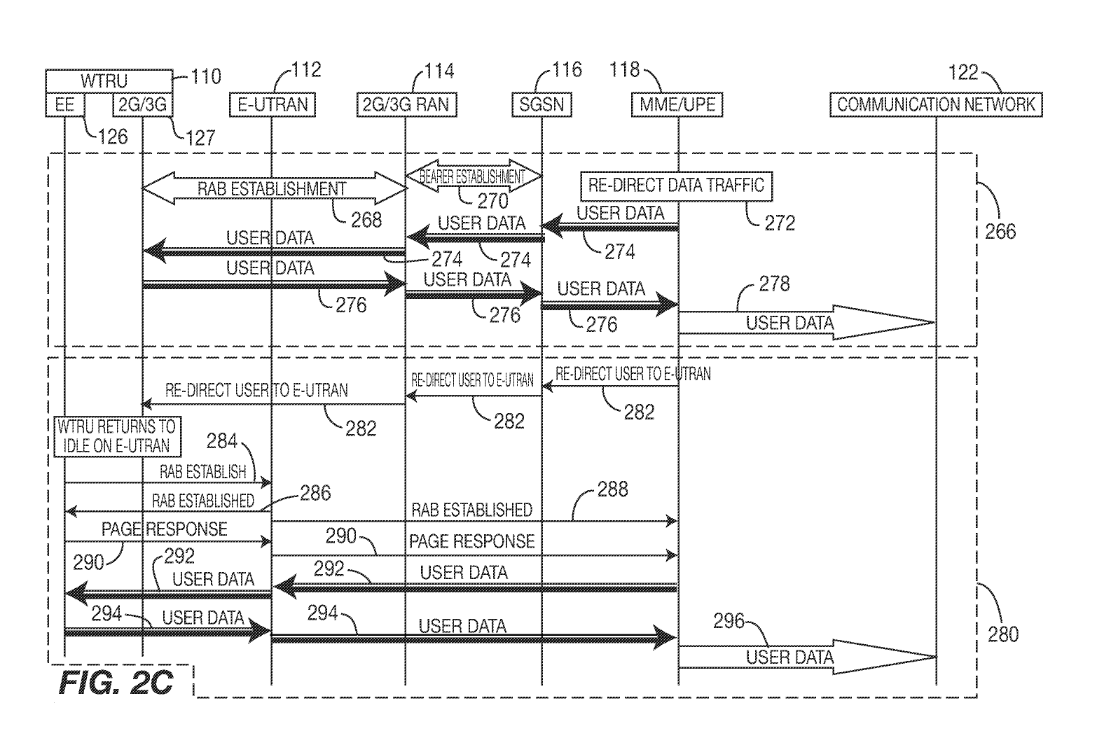

FIGS. 2A, 2B and 2C show signaling between the components of the system 100 of FIG. 1 in accordance with various embodiments of the present invention.

In the procedure 210 of FIG. 2A, the WTRU 110 powers up in the evolved mode 211 where the EE 126 of the WTRU 110 starts by attaching to the LTE system via E-UTRAN 112 and MME/UPE 118 in accordance with the present invention. In step 212, the EE 126 of the WTRU 110 sends an evolved-attachment (E-attachment) message indicating dual mode operation capability (i.e., that the WTRU 110 is capable of operating in both 2G/3G and LTE systems simultaneously) to the E-UTRAN 112. In step 214, the E-UTRAN 112 forwards the E-attachment message to the MME/UPE 118. In step 216, the MME/UPE 118 sends an attachment update message to the HLR/HSS 120 (step 216) updating the location and reachability information of the WTRU 110. The attachment update message may include in the message header an address of the MME/UPE 118 indicating that the HSS/HLR 120 should respond to MME/UPE. In step 218, the HLR/HSS 120 accepts the attachment update and sends an attachment accept message to the MME of the MME/UPE 118. In step 220, the MME/UPE 118 performs IP configuration procedures with the access stratum to allocate an IP address to the WTRU 110. Then the MME/UPE 118 sends an attachment accept message that includes the assigned IP address for the WTRU 110, a packet-temporary mobile subscriber identity (P-TMSI), an evolved-routing area (E-RA) and a 2G/3G RA), to the E-UTRAN 112. In step 222, the E-UTRAN 112 forwards the attachment accept message to the EE 126 of the WTRU 110. In step 224, a communication path is established between the SGSN 116, where the MME/UPE 118 establishes the state of the WTRU 110 as being registered in MME/UPE 118.

In procedure 230 of FIG. 2A, a service request 231 is performed, in which a user data path is established between the EE 126 of the WTRU 110 and the MME/UPE 118 in accordance with the present invention. In step 232, the WTRU 110 sends a radio access bearer (RAB) establishment request message, (including a service ID (identifying the service being requested in the service request 231), quality of service (QoS) data, and a P-TMSI), to the E-UTRAN 112 (step 232). In step 234, the E-UTRAN 112 sends a user plane bearer establishment request message, (including the service ID, the QoS data and the P-TMSI), to the MME/UPE 118. In step 236, the MME/UPE 118 responds by establishing the direct tunnel between the AS (not pictured) and the EUTRAN 112 and upon successful completion the MME/UPE 118 sends a user plane bearer establishment accept message, (including a service ID, QoS data) to the E-UTRAN 112. In step 238, the E-UTRAN 112 sends a RAB establishment accept message, (including a channel number, bandwidth and QoS data), to the EE 126 of the WTRU 110. In step 240, a user data path is established between the EE 126 of the WTRU 110 and the MME/UPE 118 such that data can be exchanged using the established path. The WTRU 110 returns to an idle mode on the E-UTRAN 112 after successfully attaching to the system if there is no data to send or receive.

In the procedure 250 of FIG. 2B, dual pages are received after the WTRU switches to the 2G/3G mode in accordance with the present invention. The 2G/3G element 127 of the WTRU 110 may switch to 2G/3G mode of operation for multiple reasons such as, better radio environment, or performing CS call. In step 252, the WTRU 110 detects the 2G/3G new routing area (RA) information and starts new RA update procedures by sending a 2G/3G RA update message to the 2G/3G RAN 114, which then forwards the 2G/3G RA update message to the SGSN 116. The SGSN then updates the HLR/HSS 120 with the new location and reachability of the WTRU 110 and establish the necessary state machine associated with this mode of operation. The SGSN 116 also detects that this is multimode WTRU 110 that has contacts in the LTE system. Upon successful operation, in step 254, the SGSN 116 sends a 2G/3G RA update response message to the 2G/3G RAN 114, which then forwards the 2G/3G RA update response message to the 2G/3G element 127 of the WTRU 110. In step 256, the SGSN 116 may exchange 2G/3G RA update messages with the MME/UPE 118 to maintain the current state of the WTRU. In step 258, a user data path is established between the communication network 122 and the MME/UPE 118. Upon reception of data to be delivered to the WTRU, in step 260, the MME/UPE 118 sends a first page message to the 2G/3G element 127 of the WTRU 110 via the SGSN 16 and the 2G/3G RAN 114. In step 262, the MME/UPE 118 then sends a second page message to the EE 126 of the WTRU 110 via the E-UTRAN 112. In step 264, the 2G/3G element 127 of the WTRU 110 sends a 2G/3G page response message to the MME/UPE 118 via the 2G/3G RAN 114 and the SGSN 116.

In procedure 266 of FIG. 2C, RABs are established and data traffic is redirected to facilitate the exchange of user data to and from the 2G/3G element 127 of the WTRU 110. In step 268, RABs are established between the 2G/3G element 127 of the WTRU 110 and the 2G/3G RAN 114. In step 270, bearer establishment signaling is exchanged between the 2G/3G RAN 114 and the SGSN 116. In step 272, the MME/UPE 118 redirects traffic to the 2G/3G path. In step 274, user data is sent from the MME/UPE 118 to the 2G/3G element 127 of the WTRU 110 via the SGSN 116 and the 2G/3G RAN 114. In step 276, user data is sent back from the 2G/3G element 127 of the WTRU 110 to the MME/UPE 118 via the 2G/3G RAN 114 and the SGSN 116. In step 278, a user data path is established between the MME/UPE 118 and the communication network 122.

The procedure 280 of FIG. 2C is an alternative to the procedure 266 to facilitate the exchange of user data to and from the EE 126 of the WTRU 110. In step 282, the MME/UPE 118 signals the 2G/3G element 127 of the WTRU 110 via the SGSN 116 and the 2G/3G RAN 114 to re-direct the user such that the WTRU 110 returns to idle on the E-UTRAN 112. In step 284, the EE 126 of the WTRU 110 sends a RAB establish message to the E-UTRAN 112. In step 286, the E-UTRAN 112 responds by sending a RAB established message to the EE 126 of the WTRU 110. In step 288, the E-UTRAN 112 sends a RAB established message to the MME/UPE 288. In step 290, the EE 126 of the WTRU 110 sends a page response message to the E-UTRAN 112, which forwards the page response message to the MME/UPE 118. In step 292, user data is sent from the MME/UPE 118 to the E-UTRAN 112, which forwards the user data to the EE 126 of the WTRU 110. In step 294, the EE 126 of the WTRU 110 sends user data back to the E-UTRAN 112, which forwards the user data to the MME/UPE 118. In step 296, the MME/UPE 118 establishes a user data path with the communication network 122.

The present invention may be implemented in the network layer (layer 3), transport layer, and/or the session layer of a 3G wireless communication system. The present invention applies to wideband code division multiple access (WCDMA) frequency division duplex (FDD) wireless communication systems.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless communication system for performing dual mode paging, the system comprising:
an evolved-universal mobile telecommunication system (UMTS) terrestrial radio access network (E-UTRAN);
a second generation (2G)/third-generation (3G) radio access network (RAN); and
at least one wireless transmit/receive unit (WTRU) including an evolved element (EE) in communication with the E-UTRAN and a 2G/3G element in communication with the 2G/3G RAN, wherein when the 2G/3G element of the WTRU receives a first page message via the 2G/3G RAN, the WTRU responds to the first page message via the 2G/3G element, and when the EE of the WTRU receives a second page message via the E-UTRAN, the WTRU responds to the second page message via the EE.

2. The wireless communication system of claim 1 further comprising:
a mobility management entity (MME)/user plane entity (UPE); and
a serving general packet radio service (GPRS) support node (SGSN) in communication with the MME/UPE and the 2G/3G RAN.

3. The wireless communication system of claim 2 wherein the MME/UPE sends the first and second page messages to the WTRU.

4. The wireless communication system of claim 3 wherein the WTRU sends a response to the first page message to the MME/UPE via the 2G/3G RAN and the SGSN.

5. The wireless communication system of claim 3 wherein the WTRU sends a response to the second page message to the MME/UPE via the E-UTRAN.

6. The wireless communication system of claim 2 wherein the WTRU sends a 2G/3G routing area (RA) update message to the 2G/3G RAN via the 2G/3G element, and the 2G/3G RAN forwards the 2G/3G RA update message to the MME/UPE.

7. The wireless communication system of claim 6 wherein the MME/UPE sends a 2G/3G RA update response message to the 2G/3G RAN, and the 2G/3G RAN forwards the 2G/3G RA update response message to the 2G/3G element of the WTRU.

8. The wireless communication system of claim 2 wherein the WTRU receives user data from the MME/UPE via the E-UTRAN.

9. The wireless communication system of claim 2 wherein the WTRU sends user data to the MME/UPE via the E-UTRAN.

10. The wireless communication system of claim 2 wherein the WTRU receives user data from the MME/UPE via the SGSN and the 2G/3G RAN.

11. The wireless communication system of claim 2 wherein the WTRU sends user data to the MME/UPE via the 2G/3G RAN and the SGSN.

12. A method of performing dual mode paging in a wireless communication system including an evolved-universal mobile telecommunication system (UMTS) terrestrial radio access network (E-UTRAN), a second generation (2G)/third-generation (3G) radio access network (RAN) and at least one wireless transmit/receive unit (WTRU) including an evolved element (EE) in communication with the E-UTRAN and a 2G/3G element in communication with the 2G/3G RAN, the method comprising:
the WTRU receiving a first page message via the 2G/3G RAN;
the WTRU responding to the first page message via the 2G/3G element;
the WTRU receiving a second page message via the E-UTRAN; and
the WTRU responding to the second page message via the EE.

13. The method of claim 12 wherein the wireless communication system further includes a mobility management entity (MME)/user plane entity (UPE) and a serving general packet radio service (GPRS) support node (SGSN) in communication with the MME/UPE and the 2G/3G RAN, the method further comprising:
the MME/UPE sending the first and second page messages to the WTRU.

14. The method of claim 13 further comprising:
the WTRU sending a response to the first page message to the MME/UPE via the 2G/3G RAN and the SGSN.

15. The method of claim 13 further comprising:
the WTRU sending a response to the second page message to the MME/UPE via the E-UTRAN.

16. The method of claim 13 further comprising:
the WTRU sending a 2G/3G routing area (RA) update message to the 2G/3G RAN via the 2G/3G element; and
the 2G/3G RAN forwarding the 2G/3G RA update message to the MME/UPE.

17. The method of claim 16 further comprising:
the MME/UPE sending a 2G/3G RA update response message to the 2G/3G RAN; and
the 2G/3G RAN forwarding the 2G/3G RA update response message to the 2G/3G element of the WTRU.

18. The method of claim 13 further comprising:
the WTRU receiving user data from the MME/UPE via the E-UTRAN.

19. The method of claim 13 further comprising:
the WTRU sending user data to the MME/UPE via the E-UTRAN.

20. The method of claim 13 further comprising:
the WTRU receiving user data from the MME/UPE via the SGSN and the 2G/3G RAN.

21. The method of claim 13 further comprising:
the WTRU sending user data to the MME/UPE via the 2G/3G RAN and the SGSN.

22. A wireless communication system for performing dual mode paging, the system comprising:
an evolved-universal mobile telecommunication system (UMTS) terrestrial radio access network (E-UTRAN);
a global system for mobile communication (GSM) enhanced data rate for global evolution (EDGE) radio access network (GERAN); and
at least one wireless transmit/receive unit (WTRU) including an evolved element (EE) in communication with the E-UTRAN and a second generation (2G)/third-generation (3G) element in communication with the GERAN, wherein when the 2G/3G element of the WTRU receives a first page message via the GERAN, the WTRU responds to the first page message via the 2G/3G element, and when the EE of the WTRU receives a second page message via the E-UTRAN, the WTRU responds to the second page message via the EE.

23. A method of performing dual mode paging in a wireless communication system including an evolved-universal mobile telecommunication system (UMTS) terrestrial radio access network (E-UTRAN), a global system for mobile communication (GSM) enhanced data rate for global evolution (EDGE) radio access network (GERAN) and at least one wireless transmit/receive unit (WTRU) including an evolved element (EE) in communication with the E-UTRAN and a second generation (2G)/third-generation (3G) element in communication with the GERAN, the method comprising:
the WTRU receiving a first page message via the GERAN;
the WTRU responding to the first page message via the 2G/3G element;
the WTRU receiving a second page message via the E-UTRAN; and
the WTRU responding to the second page message via the EE.

24. A wireless transmit/receive unit (WTRU) configured for dual mode paging, the WTRU comprising:
an evolved element (EE), for communicating with an evolved-universal mobile telecommunication system (UMTS) terrestrial radio access network (E-UTRAN);
a second generation (2G)/third generation (3G) element for communicating with a 2G/3G radio access network (2G/3G RAN); and
a processor for determining whether to communicate using the EE or the 2G/3G element; wherein when the 2G/3G element receives a first page message via the 2G/3G RAN, the processor determines to respond to the first page message using the 2/G3G element and when the EE receives a second page message via the E-UTRAN, the processor determines to respond to the second page using the EE.

25. The WTRU of claim 24 wherein the 2G/3G element is receives the first page sent from a mobility management entity (MME)/user plane entity (UPE) via the 2G/3G RAN.

26. The WTRU of claim 24 wherein the EE is receives the second page sent from a MME/UPE via the E-UTRAN.

27. The WTRU of claim 24 wherein 2G/3G element sends the response to the first page message to the MME/UPE via the 2G/3G and a serving general packet radio service (GPRS) support node (SGSN).

28. The WTRU of claim 24 wherein the 2G/3G element sends a 2G/3G routing area (RA) update message to the MME/UPE, via 2G/3G RAN.

29. The WTRU of claim 24 wherein the 2G/3G element receives a 2G/3G RA update response from the MME/UPE via the 2G/3G RAN.

30. The WTRU of claim 24 wherein the EE receives user data from the MME/UPE via the E-UTRAN.

31. The WTRU of claim 25 wherein the EE is sends user data to the MME/UPE via the E-UTRAN.

32. The WTRU of claim 25 wherein the 2G/3G element receives user data from the MME/UPE via the SGSN and the 2G/3G RAN.

33. The WTRU of claim 1 wherein the 2G/3G element sends user data to the MME/UPE via the 2G/3G RAN and the SGSN.
